(19) United States
(12) Patent Application Publication
(10) Pub. No.: US 2026/0237239 A1
(43) Pub. Date: Aug. 13, 2026

(54) ALGORITHMS FOR CUSTOMER BEHAVIOR ANALYSIS BASED ON VIDEO UNDERSTANDING WITH LONG MEMORY

(71) Applicant: Dell Products L.P., Round Rock, TX (US)

(72) Inventors: Zijia Wang, London (GB); Yichun Xu, Everett, MA (US); Michael Robillard, Shrewsbury, MA (US)

(21) Appl. No.: 19/052,123

(22) Filed: Feb. 12, 2025

(51) Int. Cl. G06V 40/20; G06V 10/82; G06V 20/40

(52) U.S. Cl. CPC G06V 40/20; G06V 10/82; G06V 20/46

(57) ABSTRACT

One example method includes processing a natural language query concerning a user in a commercial environment, based on the natural language query, extracting, from a video of the user, one or more frames that are responsive to the natural language query, and one of the frames is a key frame, analyzing customer behavior captured in the one or more frames, and based on the analyzing, obtaining an insight concerning the customer behavior.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to immersive technology and spatial computing. More particularly, at least some embodiments relate to systems, hardware, software, computer-readable media, and methods for customer behavior analysis based on video understanding with long memory.

### BACKGROUND

In the realm of video understanding, existing approaches in customer analysis and long-form video understanding have been developed by companies such as OpenAI, which have been pioneering research in integrating memory banks for extended video analysis. These companies have developed models that attempt to process video data efficiently using advanced AI frameworks, such as Video-LLaMA. These models employ sequential processing and have demonstrated the potential to handle tasks like video classification and question answering over long video sequences. However, the approaches employed in these models are often constrained by the context length limitations of large language models (LLMs), as well as high computational resource requirements due to the processing of multiple video frames simultaneously.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a schema and algorithm, according to one embodiment.

FIG. 2 discloses aspects of a schema and technical workflow, according to one embodiment.

FIG. 3 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to immersive technology and spatial computing. More particularly, at least some embodiments relate to systems, hardware, software, computer-readable media, and methods for customer behavior analysis based on video understanding with long memory.

One or more example embodiments embrace methods and architectures that may enable analysis of human behavior based on extraction of information from one or more videos. One example embodiment may be employed in a commercial context, in which the behavior of a prospective customer is analyzed, but the scope of this disclosure and any claims are not limited to that example context. Rather, the scope of this disclosure extends more broadly to analysis of any human behavior captured on video, whether in real time as video is being recorded, or after the fact after the video has been recorded.

One such example of a method may comprise operations including: extracting key frames from long customer videos, which are searched based on natural language queries; processing a natural language query, and finding those frames that best fit the query from the long customer video; identifying the most relevant frames in the long customer video based on the search query; and, based on the identifying, providing insights into specific customer behaviors. In an embodiment, beyond the key frame(s), adjacent regular frames, to a key frame, may also be considered ion an analysis to provide a broader context of customer actions and behaviors. In an embodiment, insights obtained by such an example method may help businesses understand customer preferences and behaviors, enabling strategic decision-making by the business.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may enable long-term video understanding without surpassing the computational limitations of traditional models. An embodiment may leverage natural language (NL) querying to extract relevant video segments efficiently, directly aligning video analysis with specific business queries. An embodiment may be integrated into existing systems, offering plug-and-play compatibility that enhances the long-term video analysis capabilities of existing models. An embodiment may directly support various retail applications, from analyzing customer behavior to optimizing store layouts, through its ability to process extended video data seamlessly. Various other advantages of one or more example embodiments will be apparent from this disclosure.

### A. Aspects of an Example Context for One Embodiment

The following is a discussion of aspects of a context for various embodiments. This discussion is not intended to limit the scope of the claims or this disclosure, or the applicability of the embodiments, in any way.

It is expected that immersive technology will become a key enabler of business transformation because it enables humans to interact with business information persisted in datastores, machinery represented as digital twins, and artificial intelligence easily and as equals. This idea may be referred to as the immersive enterprise. This disclosure defines an immersive enterprise as a business that leverages immersive technology to perform business transformation. This idea is aligned with what some in the industry define as spatial computing.

Within spatial or immersive environments, other ability to model and improve business processes is only constrained by the processing capabilities of the underlying infrastructure. Thus, an embodiment can leverage real-world physics, or not. An embodiment may make a simulated environment track real time operations or replay the past. Historical analysis, exploratory planning, and new product introduction all become easier. Having these capabilities available to the average business has never happened before. It has the potential to dramatically improve businesses and to reduce transactional friction.

One example embodiment, discussed elsewhere herein, is focused on the retail vertical. However, it is noted that the concepts disclosed herein are largely transferable or applicable to other verticals.

### B. Overview of Aspects of One or More Embodiments

### B.1 Introduction

The rapid advancement of immersive technology promises a significant transformation in business operations, allowing seamless interaction with digital twins, data, and AI within spatial computing environments. This shift, known as immersive enterprise, holds immense potential for revolutionizing retail. However, existing video understanding systems struggle to handle long-form video data, leading to incomplete insights and suboptimal business outcomes. At present, there does not appear to be any existing algorithms or framework that can analyze the customer behaviors based on insights obtained from video of the customer. Thus, one embodiment operates to extend the length of the video analysis algorithms.

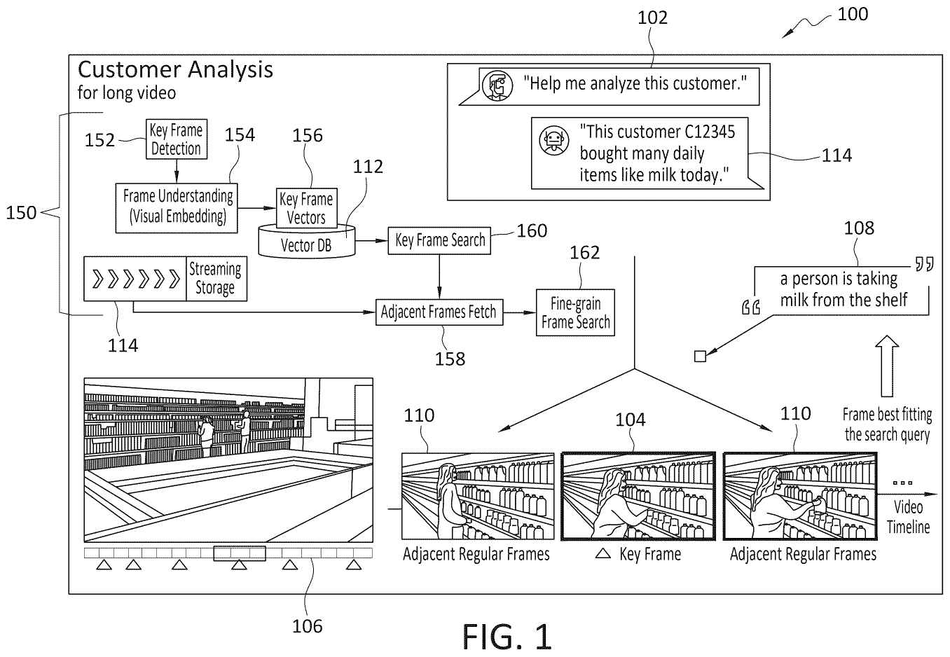

In more detail, one example embodiment address such challenges by providing a method and algorithm for performing long-term video analysis. An approach according to one embodiment comprises an enhanced workflow, as discussed below in connection with the example of FIG. 1, that utilizes advanced memory-augmented techniques for efficient retrieval and understanding of customer behaviors over extended periods. An embodiment may seamlessly integrate natural language queries to identify and extract key video segments, providing comprehensive insights that facilitate better decision-making in retail, and other, environments. A framework according to one embodiment comprises a scalable, high-fidelity solution that aligns with the immersive enterprise vision, improving customer analysis, and ultimately driving business transformation. As shown in the example of FIG. 1, discussed below, an embodiment may implement functions such as customer behavior analysis, and text-based video clip retrieval, for example.

Thus, the present disclosure is concerned with, among other things, the ability of one or more embodiments to utilize the disclosed frameworks and algorithms to harness advanced video analysis algorithms for long-form video understanding, thereby enhancing business transformation through comprehensive customer analysis. An embodiment may have the ability to utilize digital twins and AI (artificial intelligence) for seamless data interactions in retail, and other contexts, thus providing a possible advantage in obtaining customer insights. In an embodiment, the disclosed technology involves memory-augmented methods to efficiently parse extensive video data, which may be important for retail businesses to track customer behaviors and optimize operations. For example, identifying customer patterns in a store helps optimize product placement and inventory management. In more technical terms, an embodiment of a system incorporates natural language querying to extract video segments and store memory for long-term analysis.

### B.2 Discussion

As noted above, one or more embodiments comprise algorithms and infrastructure for human pose estimation. One embodiment of an algorithm for customer analysis in long-form video understanding builds upon the advancements in immersive enterprise technology, focusing on enhancing business transformation through detailed customer insights. An approach according to one embodiment comprises a memory-augmented framework that efficiently processes and analyzes extended video sequences to provide comprehensive customer behavior insights.

In more detail, embodiments may comprise various features and aspects, although no embodiment is required to possess any of such features and aspects. These features and aspects may establish a framework that significantly improves upon current video analysis methods, and may enable more advanced applications such as customer behavior analysis for immersive enterprise in retail. The following examples are illustrative, but not exhaustive.

An embodiment may comprise memory-augmented long video analysis. In particular, an embodiment may comprise a memory bank that enables an algorithm to store and recall past video information, enabling long-term video understanding without surpassing the computational limitations of traditional models.

An embodiment may comprise natural language (NL) querying. In particular, by leveraging natural language querying, an algorithm and method according to one embodiment can extract relevant video segments efficiently, directly aligning video analysis with specific business queries.

An embodiment may provide seamless integration. For example, a method and algorithm according to one embodiment may be integrated into existing systems, offering plug-and-play compatibility that enhances the long-term video analysis capabilities of existing models.

An embodiment may be useful in Business Applications. For example, a framework according to one embodiment may directly support various retail, and other, applications, from analyzing customer behavior to optimizing store layouts, through its ability to process extended video data seamlessly.

### C. Detailed Discussion of Aspects of One or More Embodiments

### C.1 Introduction

An embodiment comprises a framework for customer analysis based on the improved ability of an algorithm. An embodiment may distinguish over conventional approaches at least in that such an embodiment may leverage a memory-augmented framework that optimizes long-term video analysis while addressing these constraints. One example feature of an embodiment is the seamless integration of natural language querying, which provides a direct link between business queries and video analysis, enabling more efficient extraction of relevant video segments. Additionally, a memory bank design according to one embodiment stores and recalls past video information in a way that significantly reduces computational load while enabling accurate temporal modeling. This not only ensures that the method and algorithm of an embodiment are able to process extended video data more effectively but also enables enhanced scalability and precision in customer behavior insights, thus distinguishing an embodiment from conventional approaches.

### C.2 Discussion

### C.2.1 Example Application Workflow

One example embodiment may comprise various capabilities. Examples of such capabilities include, but are not limited to:
1. [PROCESS, INFRA, ALGO FLOW] The ability to conduct customer analysis based on long video Input.
2. [PROCESS, INFRA, ALGO FLOW] An algorithm with a memory-augmented framework.
3. [PROCESS, INFRA, ALGO FLOW] The usage of depth cameras, such as a stereoscopic camera, and local processing to capture user behavior and location.

With reference now to the example of FIG. 1, an example application workflow 100 is disclosed. The workflow 100 may be implemented by a framework that operates to analyze 102 customer behaviors by extracting key frames 104 from long customer videos 106, which may be searched based on natural language queries 108. In more detail, a natural language query 108 may comprise a search query such as “a person is taking milk from the shelf” is processed, and the framework finds frames, including the key frame 102, and possibly adjacent regular frames 110, that best fit the query from the long video. The adjacent regular frames 110 may not be directly responsive to the natural language query 108, but may provide useful context and other information that relates to a key frame 102 that is directly responsive to the natural language query 108.

With continued reference to the example of FIG. 1, an algorithm 150 according to embodiment may identify 152 the most relevant, or key, frame(s) 104 in the video based on the search query, which may comprise a natural language query 108, providing insights into specific customer behaviors. A key frame 104 may be embedded 154 in vector form to generate 156 a key frame vector that may be stored in a vector database 112. As shown, a video stream that includes a key frame 104 and one or more adjacent frames 110, such as may be obtained by one or more cameras, may be stored in a streaming storage environment 114.

Beyond a key frame 104, adjacent frames 110 may also be considered to provide a broader context of customer actions and behaviors. In the example of FIG. 1, one or more adjacent frames 110 may be retrieved 158 from the streaming storage environment 154, and a key frame search 160 performed over the retrieved adjacent frames 110 to attempt to find a key frame referenced in the vector database 112. By limiting the scope of the key frame 104 search 160 to the fetched 158 adjacent frames 110, an embodiment may implement a relatively fine-grained search 162. As in the case of the key frames 104, a natural language query process may also be used for identifying and retrieving one of more adjacent frames 110.

Once the key frames 104, and possibly one or more adjacent frames 110 as well, have been identified and obtained, those various frames may then be used to generate insights 114 that help businesses understand customer preferences and behaviors, enabling strategic decision-making. The insights 114 may also be evaluated as part of a process for customer behavior analysis.

### C.2.2 Example Technical Workflow

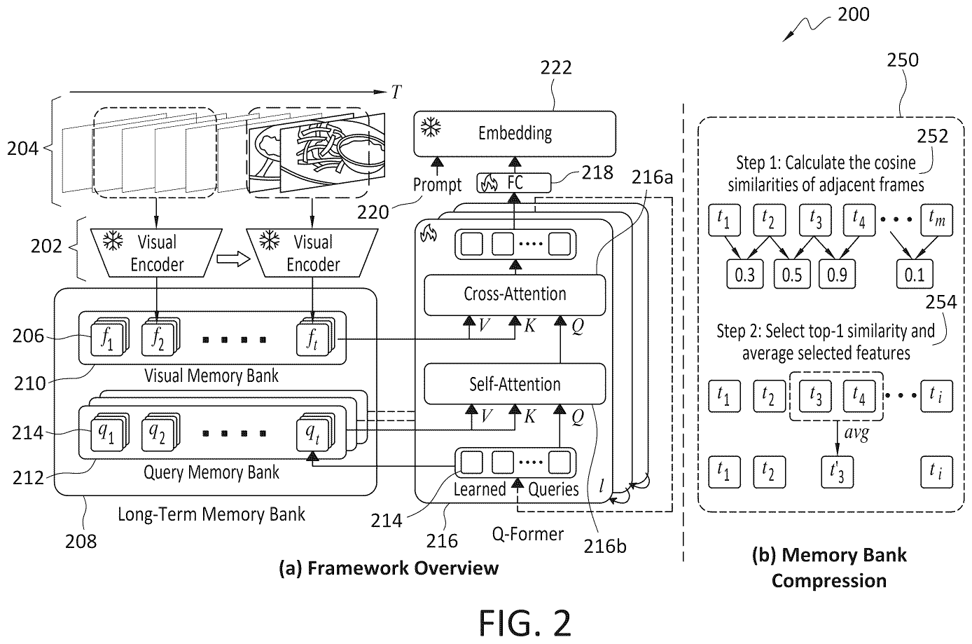

With the example of FIG. 1 in view, attention is directed now to FIG. 2 as well, which discloses an architecture 200 according to one example embodiment. As shown there, the architecture 200 may comprise a visual encoder 202 that processes video frames 204 sequentially, producing visual features 206, such as in vector form, for each frame (f1,f2, . . . , ft). The architecture 200 may comprise a long-term memory bank 208 that may comprise two portions, namely, a visual memory bank 210 that may store the visual features 206 extracted from the video frames 204, and a query memory bank 212 that may store learned query features 214 (q1,q2, . . . , qt).

As well, the architecture 200 may comprise a Q-Former 216 that may comprise a querying transformer, or Q-Former, with several cascaded blocks and may operate to perform aligning of the visual and text embedding spaces. In the example of FIG. 2, the Q-Former 216 may comprise both cross-attention layers 216a and self-attention layers 216b. The cross-attention layers 216a may serve to align the features of a current video frame with historical visual features 206 stored in the visual memory bank 210. The self-attention layers 216b may be used for modelling interactions within the learned queries 214 in the query memory bank 212.

With continued reference to the example of FIG. 2, the architecture 200 may be operable to perform a long-term memory bank compression procedure 250. In one embodiment, the procedure 250 compresses the stored video frames, reducing redundancies by calculating the cosine similarity 252 between adjacent frame features and averaging the most similar frame features, thereby preserving 254 discriminative information while maintaining the memory bank length at a shorter length than if the compression had not been performed.

Finally, the output from the Q-Former 216 may be fed into a large language model (LLM) 218 to produce, based on a prompt 220, text-based responses 222 for various video understanding tasks. For example, the LLM 218 may perform an analysis of video to identify, for example, what is being displayed in the video. This may include identifying, for example, products purchase by a user, and movement of the user through a commercial retail space.

### D. Further Discussion and Example Use Cases

As disclosed herein, an algorithm and method according to an embodiment comprises a memory-augmented framework that stores and retrieves historical video data efficiently. By using a long-term memory bank comprising both a visual memory bank and a query memory bank, the framework overcomes the limitations of large language models (LLMs) regarding context length and high computational requirements. This approach enables efficient long-term video understanding, storing past visual features and learned queries for sequential frame analysis. This approach enables an embodiment of the model to analyze long videos while maintaining computational efficiency.

Moreover, a framework according to one embodiment incorporates natural language querying to identify and extract relevant video frames, providing a direct connection between business questions and video data. In an embodiment, this information is used as a basis to conduct high-level customer behavior analysis. This capability enables users to input descriptive queries, like “a person is taking milk from the shelf,” to find, and highlight, key video frames matching the query. The memory-augmented framework ensures that the search is efficient and precise, enabling the system to capture subtle customer behaviors and patterns from long videos that would otherwise be missed. This querying mechanism enables an embodiment to be well-aligned with business applications requiring high-fidelity customer insights.

Following are some example use cases for one or more embodiments. These are provided only by way of illustration, and are not intended to limit the scope of this disclosure or any claims, in any way.

One example use case for an embodiment concerns customer behavior analysis. As shown in the example of FIG. 1, an embodiment may ask an LLM to analyze the customer behavior based on the input video. As well, an embodiment may enable entry, and use, of commands to find specific video clips.

Another example use case for an embodiment concerns behavior monitoring in a ‘smart city’ context. In particular, an embodiment may be used to monitor user behavior that violates regulations in numerous locations. As well, an embodiment might be used in apartment communities to monitor residents who do not clean up after their dogs. Further, an embodiment may be used at a non-smoking building to monitor if there are any people smoking in an area-such as a balcony, parking garage, outside of a building-that lacks a smoke detector that could respond if a person who was smoking started a fire.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.

Embodiment 1. A method, comprising: processing a natural language query concerning a user in a commercial environment; based on the natural language query, extracting, from a video of the user, one or more frames that are responsive to the natural language query, and one of the frames comprises a key frame; analyzing customer behavior captured in the one or more frames; and based on the analyzing, obtaining an insight concerning the customer behavior.

Embodiment 2. The method as recited in any preceding embodiment, wherein the one or more frames extracted from the video comprises one or more regular frames adjacent to the key frame.

Embodiment 3. The method as recited in any preceding embodiment, wherein the analyzing is based in part on historical information obtained from another video.

Embodiment 4. The method as recited in any preceding embodiment, wherein after the processing of the natural language query, a search is performed to identify the one or more frames.

Embodiment 5. The method as recited in any preceding embodiment, wherein the video is compressed and added to a long-term memory bank for use in generating responses to future natural language queries.

Embodiment 6. The method as recited in any preceding embodiment, wherein the natural language query is added to a long-term memory bank for use in generating responses to future natural language queries.

Embodiment 7. The method as recited in any preceding embodiment, wherein a querying transformer aligns features of one of the frames with historical visual elements stored in a visual memory bank.

Embodiment 8. The method as recited in any preceding embodiment, wherein a querying transformer aligns text from the natural language query with a learned query stored in a query memory bank.

Embodiment 9. The method as recited in any preceding embodiment, wherein an output of a querying transformer is provided to a LLM (large language model) that generates a text-based response to the natural language query.

Embodiment 10. The method as recited in any preceding embodiment, wherein the video is added to a long-term memory bank that includes other frames that have been compressed by removal of redundancies from the other frames, as determined by cosine similarity between the other frames and frames adjacent to the other frames, and averaging of those frames of the other frames that are most similar to each other.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

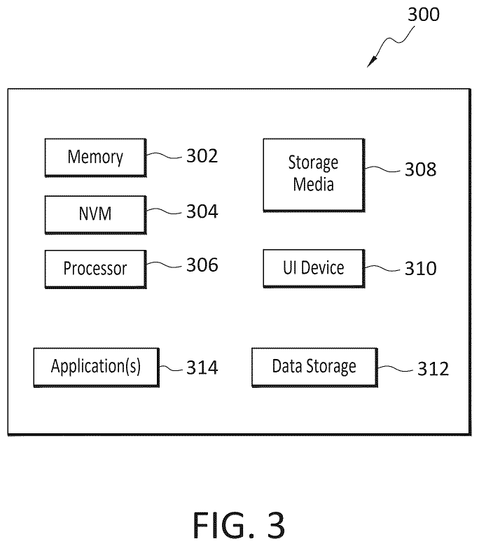

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
processing a natural language query concerning a user in a commercial environment;
based on the natural language query, extracting, from a video of the user, one or more frames that are responsive to the natural language query, and one of the frames comprises a key frame;
analyzing customer behavior captured in the one or more frames; and
based on the analyzing, obtaining an insight concerning the customer behavior.

2. The method as recited in claim 1, wherein the one or more frames extracted from the video comprises one or more regular frames adjacent to the key frame.

3. The method as recited in claim 1, wherein the analyzing is based in part on historical information obtained from another video.

4. The method as recited in claim 1, wherein after the processing of the natural language query, a search is performed to identify the one or more frames.

5. The method as recited in claim 1, wherein the video is compressed and added to a long-term memory bank for use in generating responses to future natural language queries.

6. The method as recited in claim 1, wherein the natural language query is added to a long-term memory bank for use in generating responses to future natural language queries.

7. The method as recited in claim 1, wherein a querying transformer aligns features of one of the frames with historical visual elements stored in a visual memory bank.

8. The method as recited in claim 1, wherein a querying transformer aligns text from the natural language query with a learned query stored in a query memory bank.

9. The method as recited in claim 1, wherein an output of a querying transformer is provided to a LLM (large language model) that generates a text-based response to the natural language query.

10. The method as recited in claim 1, wherein the video is added to a long-term memory bank that includes other frames that have been compressed by removal of redundancies from the other frames, as determined by cosine similarity between the other frames and frames adjacent to the other frames, and averaging of those frames of the other frames that are most similar to each other.

11. A non-transitory storage medium having stored therein instructions that are executable by one or more hardware processors to perform operations comprising:
processing a natural language query concerning a user in a commercial environment;
based on the natural language query, extracting, from a video of the user, one or more frames that are responsive to the natural language query, and one of the frames comprises a key frame;
analyzing customer behavior captured in the one or more frames; and
based on the analyzing, obtaining an insight concerning the customer behavior.

12. The non-transitory storage medium as recited in claim 11, wherein the one or more frames extracted from the video comprises one or more regular frames adjacent to the key frame.

13. The non-transitory storage medium as recited in claim 11, wherein the analyzing is based in part on historical information obtained from another video.

14. The non-transitory storage medium as recited in claim 11, wherein after the processing of the natural language query, a search is performed to identify the one or more frames.

15. The non-transitory storage medium as recited in claim 11, wherein the video is compressed and added to a long-term memory bank for use in generating responses to future natural language queries.

16. The non-transitory storage medium as recited in claim 11, wherein the natural language query is added to a long-term memory bank for use in generating responses to future natural language queries.

17. The non-transitory storage medium as recited in claim 11, wherein a querying transformer aligns features of one of the frames with historical visual elements stored in a visual memory bank.

18. The non-transitory storage medium as recited in claim 11, wherein a querying transformer aligns text from the natural language query with a learned query stored in a query memory bank.

19. The non-transitory storage medium as recited in claim 11, wherein an output of a querying transformer is provided to a LLM (large language model) that generates a text-based response to the natural language query.

20. The non-transitory storage medium as recited in claim 11, wherein the video is added to a long-term memory bank that includes other frames that have been compressed by removal of redundancies from the other frames, as determined by cosine similarity between the other frames and frames adjacent to the other frames, and averaging of those frames of the other frames that are most similar to each other.
